(19) United States
(12) Patent Application Publication
(10) Pub. No.: US 2005/0237332 A1
(43) Pub. Date: Oct. 27, 2005

(54) Information processor

(75) Inventors: Toru Matsui, Osaka (JP); Satoshi Shigenaga, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/111,858

(22) Filed: Apr. 22, 2005

(30) Foreign Application Priority Data
Apr. 23, 2004 (JP) P.2004-128499

(51) Int. Cl. G06F 12/06; G09G 5/36; G06F 13/14; G06F 13/28

(52) U.S. Cl. 345/553; 345/520; 345/572

(57) ABSTRACT

To increase the responsibility of the system by reducing the time occupied by memory means. An information processor includes an instruction parallel processor that executes the process by accessing a local memory, at least one function block that accesses the local memory, and a local memory interface that transfers data in split form from the local memory to the instruction parallel processor.

### BACKGROUND OF THE INVENTION

1. Field of the Invention

The present invention relates to an information processor.

2. Description of the related art

In systems that process various information such as a drawing instruction list, a drawing frame, texture, and a Z buffer in the local memory of a graphics processor, the capability of data transmission with the local memory have a large influence on its performance. Recent car navigation systems have access to the local memory in time-varying image processing and speech processing in addition to map drawing, and so have increased in the amount of data transmission with the local memory.

Known methods for increasing the efficiency of access to the local memory include a method of reducing write time by detecting discontinuous addresses when a graphics processor writes data into the local memory and making access to the local memory with continuous addresses every time (e.g., refer to JP-A-11-133945).

Although the foregoing known method takes into consideration to increase the efficiency of access in writing data into the local memory However, it has the problem that when making long-time data transfer at a time in reading the data from the local memory, another process that uses the data memory is kept waiting, and so the start of the processing is delayed.

For example, as car navigation systems grow more sophisticated, the drawing instruction list is increased in length with an increase in display screen size and increased complexity of the map, thus increasing a data transfer amount to read the drawing instruction list from the local memory. Accordingly, the time to transfer the drawing instruction list is increased, so that the start of another process that uses the local memory is delayed, resulting in a decrease in the responsibility of the system.

### SUMMARY OF THE INVENTION

The present invention has been made in light of such circumstances. Accordingly, it is a first object of the invention to provide an information processor in which the time occupied by memory accessing means is reduced to increase the responsibility of the system. It is a second object of the invention to provide an information processor capable of accessing, when a second bus having a width larger than that of a first bus, the information processor can access from the first bus to the second bus by single access. It is a third object of the invention to provide an information processor capable of starting function blocks at high speed.

An information processor according to the invention comprises a memory unit that stores a display list, a processing unit that reads the display list from the memory unit and performs a process according to the display list, at least one function block that accesses the memory unit, and a transfer unit that transfers data from the memory unit to the processing unit, wherein the transfer unit transfers the data in split form.

With the above structure, the data from the memory unit to the processing unit is transferred in split form. Accordingly, the time occupied by the memory unit per access can be reduced, so that the start of other processes that use the memory unit is not kept waiting for a long time, thus increasing the responsibility of the system. With the above structure, the function block can access the memory unit during the split transfer, thus increasing the responsibility of the system.

Preferably, the information processor according to the invention further comprises a first bus for access between the processing unit and the function block and a second bus for access between the processing unit and the memory unit, wherein the first bus and the second bus are independent from each other. With the above structure, the first bus and the second bus are independent from each other, so that the processing unit can perform parallel processing, thus increasing the processing efficiency.

In the information processor according to the invention, preferably, when transferring the data in split form, the transfer unit transfers the data in a predetermined order of priority in response to a data transfer request.

An information processor according to the invention includes a bus access unit that accesses a second bus having a width larger than that of a first bus from the first bus. The processor comprises a storage unit that stores an address transferred from the first bus as part of an address necessary for accessing the second bus, an address generation unit that detects that an access request from the first bus to the second bus has been generated by the access to the storage means and generates part of the address necessary for accessing the second bus, and a connecting unit that connects the address transferred from the first bus, the address stored in the storage unit, and the address generated by the address generation unit and transfers the connected address to the second bus.

With the above structure, an address having a width larger than that of the first bus can be generated by adding the stored address, the address transferred from the first bus, and the generated address, so that access to the second bus having a width larger than that of the first bus can be made by single access. With the above structure, when an invariant address is stored in the memory unit in advance, a desired address can be specified by connecting the variable address transferred from the first bus, the stored invariant address, and the generated address. This allows access to the second bus from the first bus by single access, thereby reducing the number of accesses.

An information processor according to the invention comprises at least one function block, a processor that activates the function block by the access to the function block, and a notification unit that notifies the processor of an error of the access to the function block.

With the above structure, the notification unit that notifies the processor of the error of access to the function block is provided. Accordingly, the processor can start the function block according to the notification without determination on access by itself, thus allowing high-speed activation of the function block.

Preferably, the information processor according to the invention further comprises a unit that disables access to the function block during the execution of the function block. The above structure allows notification of an access error while maintaining the internal state by disabling the access during the execution of the function block.

In the information processor according to the invention, preferably, the function block comprises a starting register for performing startup setting and a two-step parameter register having a first register that holds a parameter necessary for operation by the access from the processor and a second register that holds the contents from the first register at the setting of the starting register. With the above structure, the system executes the process according to the parameter stored in the second register, during which a new parameter can be set to the first register. This allows parameter setting during the execution of the function block, thus allowing high-speed processing.

According to the invention, the time occupied by the memory unit per access can be reduced by split transfer of data from the memory unit to the processing unit, so that the start of other processes that use the memory unit is not kept waiting for a long time, thus increasing the responsibility of the system. Also, the function block can access the memory unit during the split transfer, thus increasing the responsibility of the system.

According to the invention, an address having a width larger than that of the first bus can be generated by adding the stored address, the address transferred from the first bus, and the generated address, so that access to the second bus having a width larger than that of the first bus can be made by single access. With the above structure, when an invariant address is stored in the memory unit in advance, a desired address can be specified by connecting the variable address transferred from the first bus, the stored invariant address, and the generated address. This allows access to the second bus from the first bus by single access, thereby reducing the number of accesses.

According to the invention, the notification unit that notifies the processor of the error of access to the function block is provided. Accordingly, the processor can start the function block according to the notification without determination on access by itself, thus allowing high-speed activation of the function block.

### BRIEF DESCRIPTION OF THE DRAWINGS

FIG. 1 is a schematic block diagram for explaining a graphics processor according to a first embodiment of the invention and a graphics system to which the graphics processor is mounted.

FIG. 2 is a flowchart showing the outline of the process of the graphics processor in FIG. 1.

FIGS. 3(1) and 3(2) are explanatory diagrams showing the operating state of an instruction parallel processor.

FIGS. 4(1) and 4(2) are explanatory diagrams showing the operating state of an instruction parallel processor.

FIG. 5 is an explanatory diagram of a bus error signal for avoiding a long-time locked state.

FIG. 6 is a flowchart for explaining a second embodiment of the invention.

FIG. 7 is an internal schematic diagram of a bus arbitration unit for explaining right-to-use-bus request signals.

FIG. 8 is a diagram for explaining the flow of data in the bus arbitration unit.

FIG. 9 is a flowchart for explaining the operation of the memory-access arbitration section in FIG. 7.

FIG. 10 is a diagram in which the address map of a control bus area is shown.

FIG. 11 is a diagram in which the address map of a processor local bus is shown.

FIG. 12 is a diagram for explaining the access of the processor local bus.

FIG. 13 is a time chart showing the protocol of the processor local bus.

FIG. 14 is a diagram for explaining another access of the processor local bus.

FIG. 15 is a flowchart until a normal drawing instruction is started.

FIG. 16 is a flowchart until a normal drawing instruction is started when a register-access error flag is used.

FIG. 17 is a flowchart until a normal drawing instruction in a two-step register is started.

FIG. 18 is a flowchart until a drawing instruction is started when a register-access error flag is used in the two-step register.

### DESCRIPTION OF THE PREFERRED EMBODIMENTS

(First Embodiment)

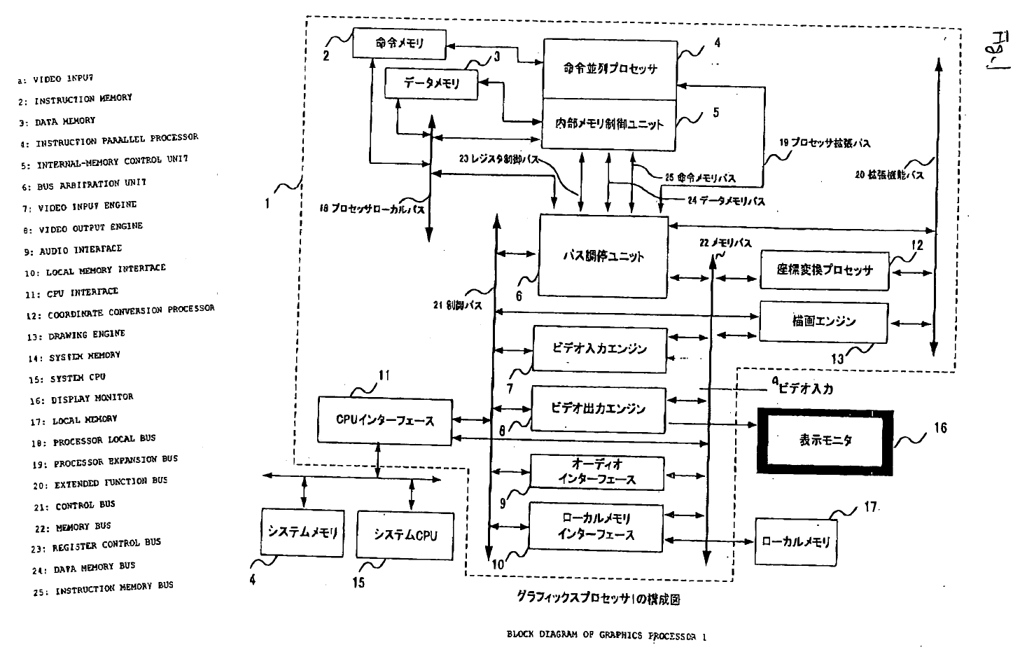

FIG. 1 is a schematic block diagram for explaining a graphics processor according to a first embodiment of the invention and a graphics system in which the graphics processor is mounted. In FIG. 1, a graphics processor 1 principally includes an instruction parallel processor 4 that executes a process by making access to a local memory 17, a function block (to be described later) that makes access to the local memory 17, and a local memory interface 10 that transfers data from the local memory 17 to the instruction parallel processor 4.

The instruction parallel processor 4 reads a display list (hereinafter, referred to as a DL) containing a drawing instruction from the local memory 17, contents set to the function block, etc. and processes them. The local memory interface 10 transfers data in sequence in response to multiple data transfer instructions in a predetermined order of priority or the order of transfer instructions.

The region to which the instruction parallel processor 4 has access is divided into four regions of a resistor space, a memory space, an extended register space, and an IO space.

The register space corresponds to the register area of a bus arbitration unit 6 for controlling the bus between an internal-memory control unit 5 and a control bus 21, a memory bus 22, and so on, a video input engine 7 for bringing in video information and storing it into the local memory 17, a video output engine 8 for reading drawing data from the local memory 17 and outputting it to a display monitor 16, an audio interface 9 for outputting audio data, the local memory interface 10 for controlling the access to the local memory 17, and a CPU interface 11 that controls the access to a system CPU 15, and part of the register of coordinate conversion processor 12 for coordinate conversion processing and a floating-point operation and a drawing engine 13 for graphics processing. The memory space corresponds to a local memory area. The foregoing function block includes the video input engine 7, the video output engine 8, the audio interface 9, the local memory interface 10, the CPU interface 11, the coordinate conversion processor 12, and the drawing engine 13.

The extended space corresponds to part of the register of the coordinate conversion processor 12 and the drawing engine 13. The 10 space corresponds to the internal-memory control unit 5, an instruction memory 2, and a data memory 3.

Internal buses present in the graphics processor 1 include the control bus 21 used when the instruction parallel processor 4 sets parameters to the function block in the register area and when the system CPU 15 accesses the area in the graphics processor 1 via the CPU interface 11, the memory bus 22 used for data transfer when the instruction parallel processor 4, the video input engine 7, the video output engine 8, the audio interface 9, the coordinate conversion processor 12, and the drawing engine 13 access the local memory 17, an extended function bus 20 used when the instruction parallel processor 4 performs parameter setting and start-up process to the coordinate conversion processor 12 and the drawing engine 13, and a processor local bus 18 for access to the instruction memory 2 and the data memory 3. The extended function bus 20, the control bus 21, and the memory bus 22 which are used for access between the instruction parallel processor 4 and the functional block, and the processor local bus 18 used for access between the instruction parallel processor 4 and the local memory 17 are independently provided.

The internal-memory control unit 5 has a register control bus 23 used for access from the instruction parallel processor 4 to the block connected to the control bus 21 and the processor local bus 18, a data memory bus 24 used for transferring data from the instruction parallel processor 4 to the local memory 17, and an instruction memory bus 25 used for filling instruction codes from the local memory 17 into the instruction parallel processor 4.

The bus arbitration unit 6 controls the access of the instruction parallel processor 4 to the instruction memory 2 and the data memory 3 used by the instruction parallel processor 4, the access of the internal-memory control unit 5 that controls the other register areas and memory areas, and the access between the internal-memory control unit 5 and the control bus 21, the memory bus 22, the processor local bus 18, a processor expansion bus 19, and the extended function bus 20. Briefly, the bus arbitration unit 6 accesses from the control bus 21 to the processor local bus 18 having a width larger than that of the control bus 21.

The bus arbitration unit 6 and the instruction parallel processor 4 are connected together with the register control bus 23, the data memory bus 24, the instruction memory bus 25, the processor expansion bus 19, and the processor local bus 18 via the internal-memory control unit 5.

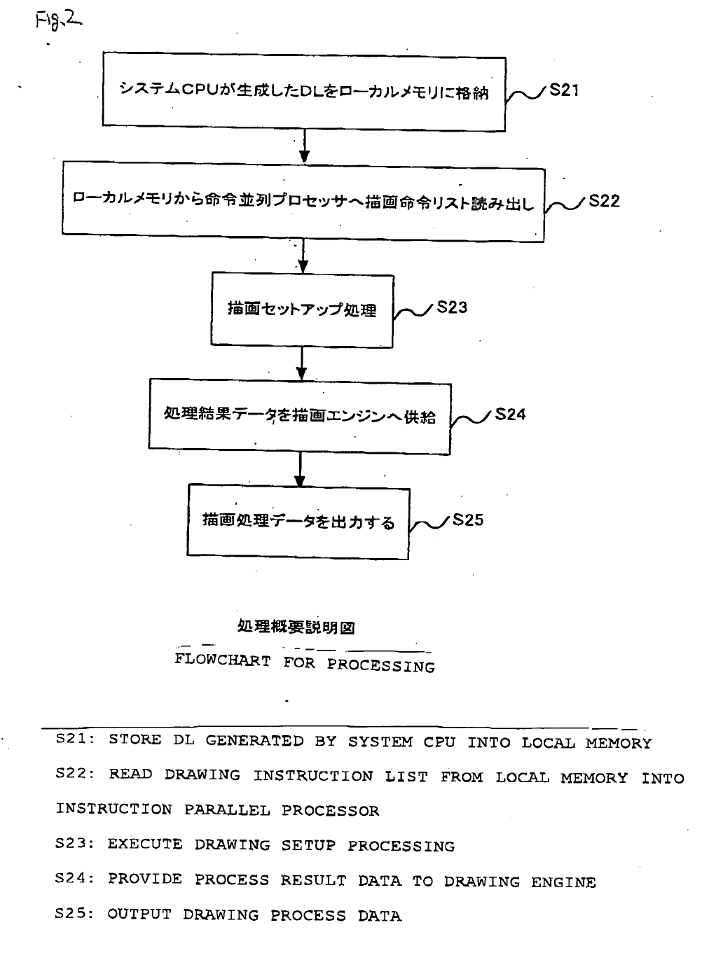

FIG. 2 is a flowchart showing the outline of the process of the graphics processor 1 in FIG. 1. The graphics processor 1 stores a DL containing a drawing instruction and contents set to the function block, which is generated by the system CPU 15, into the local memory 17 (step S21), then provides the DL read from the local memory 17 to the data memory 3 of the instruction parallel processor 4 (step S22), performs setup processing by the instruction parallel processor 4 (step S23), and provides process result data to the drawing engine 13 and so on (step S24).

The drawing engine 13, which has received the process result data, converts it to drawing data, and stores the converted drawing data in the local memory 17. The video output engine 8 reads the drawing data from the local memory 17 and outputs it to the display monitor 16 (step S25).

(Parallel Processing)

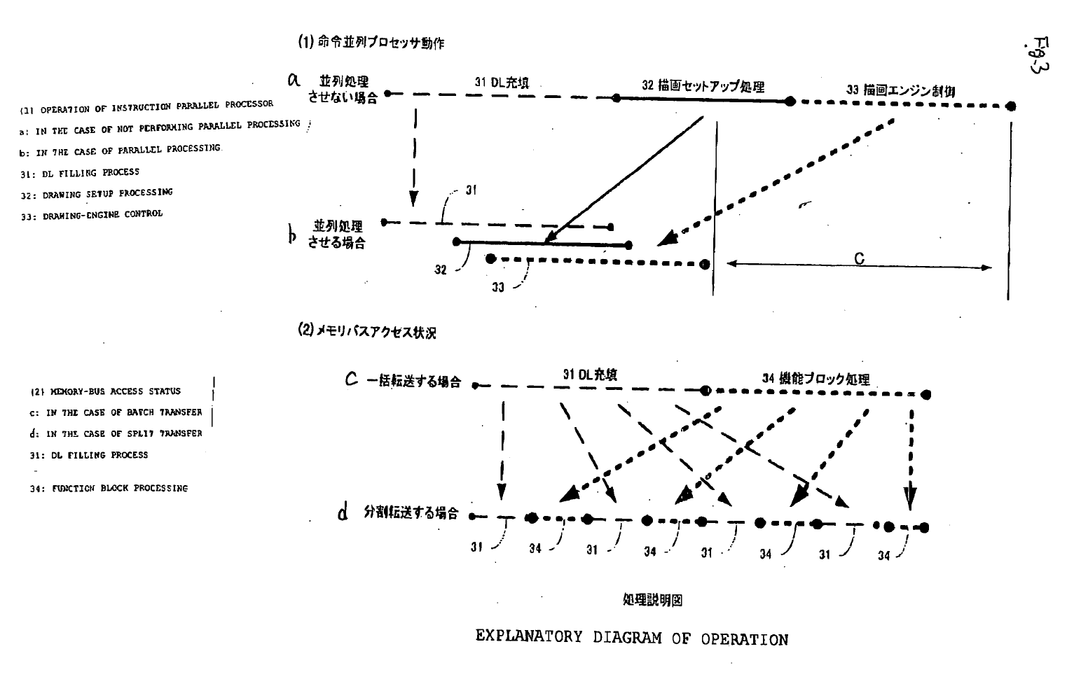

FIGS. 3(1) is explanatory diagrams showing the operating state of the instruction parallel processor 4. FIG. 3(1) shows the operating state of the instruction parallel processor 4 in FIG. 1, in which a process in the case where the instruction parallel processor 4 does not perform parallel processing (a of FIG. 3(1)a) and a process in the case where the instruction parallel processor 4 performs parallel processing (FIG. 3(1)b) are shown.

A DL filling process 31 shown in FIG. 3(1) means reading of a drawing instruction list from the local memory 17 to the instruction parallel processor 4, shown in step S22 of FIG. 2. Drawing setup processing 32 means drawing setup processing shown in step S23 of FIG. 2. Drawing-engine control 33 means providing process result data to the drawing engine 13, shown in step 524 of FIG. 2.

As shown in FIG. 3(1)b, the DL filling process 31, the drawing setup processing 32, and the drawing-engine control 33 can be performed in parallel by the parallel processing of the instruction parallel processor 4. Accordingly, the processing hours of the instruction parallel processor 4 can be reduced by period C in the lower row of FIG. 3(1). Here the amount of DL filling at one time must be constant for the instruction parallel processor 4 to perform parallel processing. Thus the drawing setup processing can be started at a specified timing and as such, the parallelism can be maintained. When all the data sizes of the drawing instructions are equal, DL filling may be performed under a fixed number of instructions or may be performed every instruction, in addition to the constant amount of DL filling. Also, In the DL filling process, not all the last-filled drawing instruction can be transferred, since normal drawing instructions are not equal in data size. In that case, drawing instructions left in the processor may be stored and processed together with the following drawing instruction in the next DL filling.

(Bus Arbitration)

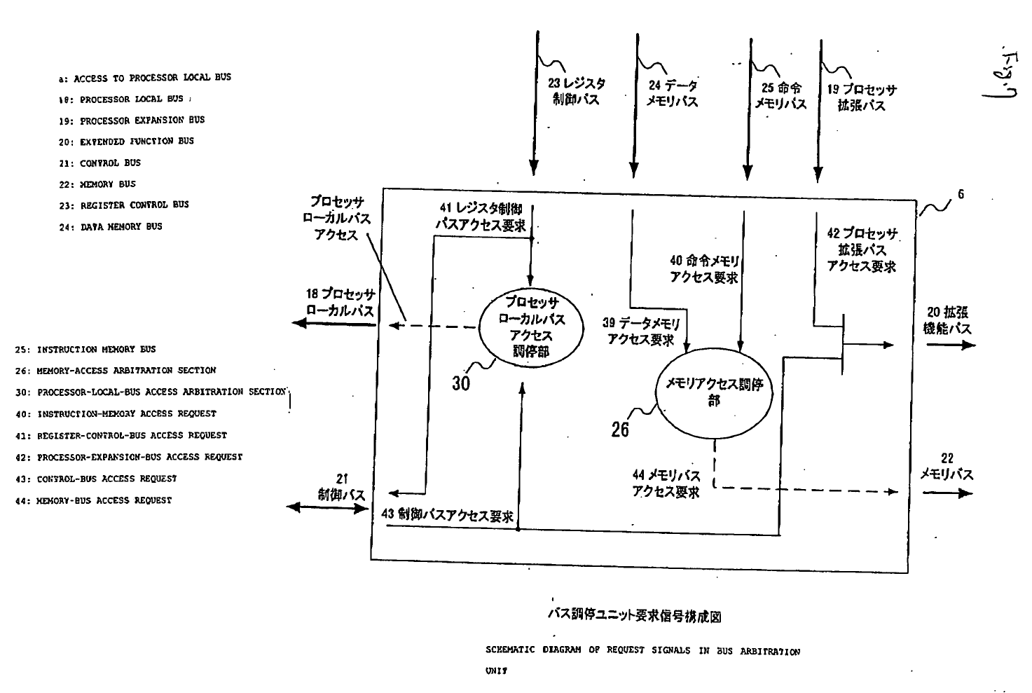

FIG. 7 is an internal schematic diagram of the bus arbitration unit 6 for explaining right-to-use-bus request signals. There are two master-side buses that access the memory bus 22, the instruction memory bus 25 and the data memory bus 24. They are controlled by a memory-access arbitration section 26 in the bus arbitration unit 6 to access the memory bus 22.

Similarly, two buses, the register control bus 23 and the control bus 21, access the processor local bus 18 as the master-side bus. The access to the processor local bus 18 is arbitrated by a processor-local-bus access arbitration section 30 in the bus arbitration unit 6.

The register control bus 23 serves as the master-side bus for the control bus 21, while the control bus 21 is connected to the extended function bus 20 in such a way as to serve as the master-side bus. Also the processor expansion bus 19 acts as the master for the extended function bus 20. However, it is determined by register setting which of the processor expansion bus 19 and the control bus 21 accesses the extended function bus 20.

The internal operation of the bus arbitration unit 6 in this case will be described with reference to FIG. 7. The DL filling process 31 shown in FIG. 3(1) is accessing to the bus arbitration unit 6 as an access request from the data memory bus 24. A data-memory access request 39 in FIG. 7 corresponds to it. The drawing-engine control 33 shown in FIG. 3(1) is accessing to the bus arbitration unit 6 as a write request from the processor expansion bus 19. A processor-expansion-bus access request 42 in FIG. 7 corresponds to it. Since the bus for issuing the request and its destination bus are independent from each other, they can be operated independently in the bus arbitration unit 6.

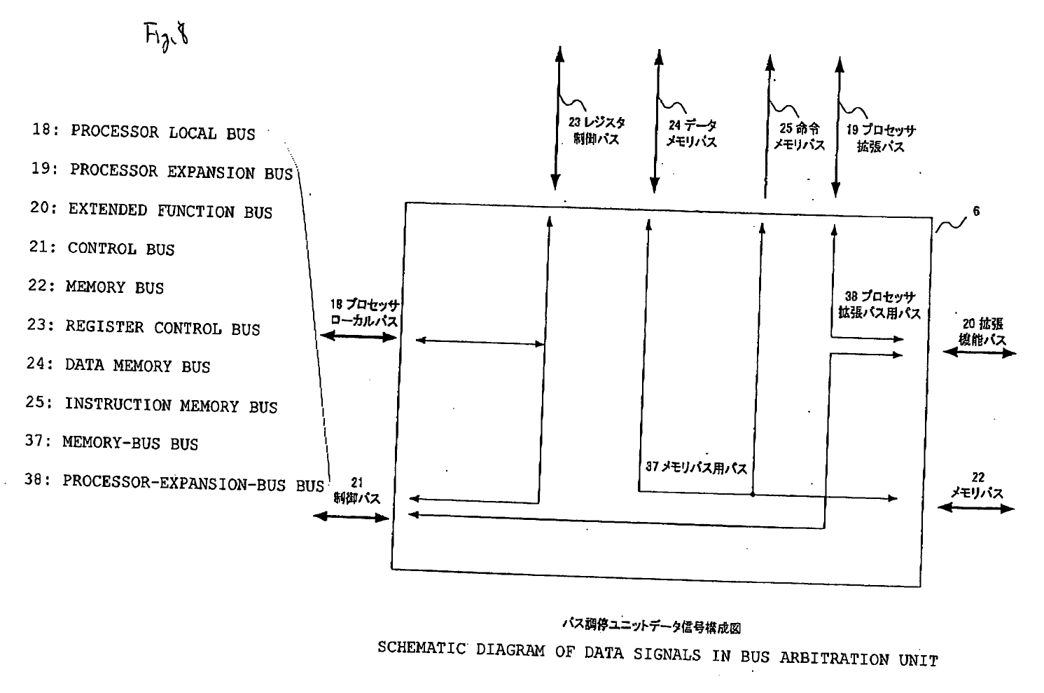

The flow of data in the bus arbitration unit 6 will be described with reference to FIG. 8 which is a schematic figure of FIG. 7. For the DL filling process 31 shown in FIG. 3(1), or the access request from the data memory bus 24, DL data is read using a memory-bus bus 37 in FIG. 8. For the drawing-engine control 33 shown in FIG. 3(1), or the access request from the processor expansion bus 19, parameter setting etc. are performed for the drawing engine 13 by using a processor-expansion-bus bus 38 in FIG. 8. Thus, both of the request signals and data are independent in the bus arbitration unit 6, so that parallel processing can be performed without keeping the instruction parallel processor 4 waiting.

(Split Processing)

FIG. 3(2) shows the access status of batch transfer of data to the local memory 17 shown in FIG. 1 (FIG. 3(2)c) and split transfer of data (FIG. 3(2)d). Function block processing 34 shown in FIG. 3(2) means output of drawing data shown in step S25 of FIG. 2, which also includes access to the local memory 17 which is performed by the video output engine 8 other than the drawing engine 13 for display processing.

As shown in FIG. 3(2), splitting the access to the local memory 17 (FIG. 3(2)d) allows function block processing to be performed quickly, thus increasing the responsibility of the system as compared with that of batch transfer (FIG. 3(2)c).

(Bus-Lock Detection)

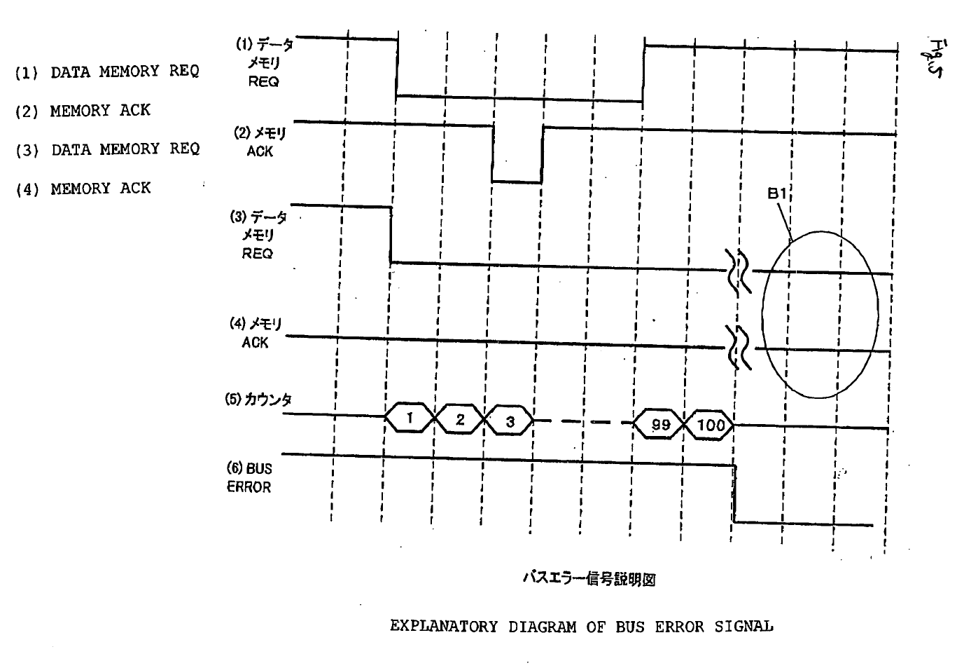

FIG. 5 is an explanatory diagram of a bus error signal for avoiding a long-time locked state. As shown in FIG. 5, a REQ signal is asserted for the bus arbitration unit 6 in the access of the instruction parallel processor 4 to the instruction memory bus 25 or the data memory bus 24. All the signals in FIG. 5 are asserted LOW. All the vertical dotted lines indicate rising edges of the clock.

In the conventional collective request method shown in FIG. 3(1), each access period is long. This makes it difficult to determine whether the other blocks are being accessed or some defect occurs on the system, thereby locking the memory bus 22, only from the waiting time until bus right is obtained (B1 in FIG. 5 shows a state in which a memory ACK signal does not return).

However, the split processing as in the embodiment decrease the time required for the accesses, and so it can be seen that some problem occurs in the system, so that the bus or the system is locked somewhere, by counting the waiting time.

Referring to FIG. 5(5), an error signal (a BUS ERROR signal in FIG. 5(6)) is asserted at the time of count 100. Accordingly, for example, a long-time locked state can be avoided by mounting a circuit, on the system, that asserts the bus error signal for the instruction parallel processor 4 and the system CPU 15 when the acknowledge signal (memory ACK signals in FIG. 5) is not asserted even after a fixed time.

(Second Embodiment)

An example of a case in which drawing processing and media processing are performed in parallel using the instruction parallel processor 4 will now be described.

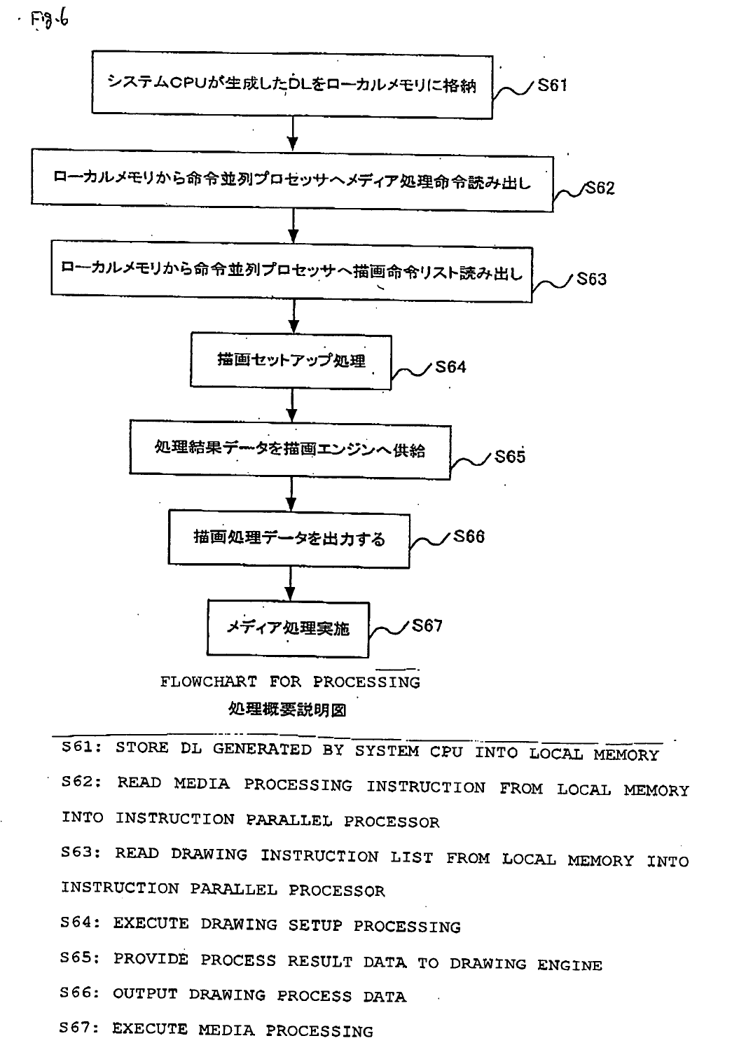

FIG. 6 is a flowchart for explaining a second embodiment of the invention, in which the graphics processor 1 performs drawing processing and media processing in parallel. After the DL generated by the system CPU 15 and a media processing instruction have been stored in the local memory 17 (step S61), the graphics processor 1 reads the media processing instruction from the local memory 17 and fills it into the instruction memory 2 (step S62).

The DL is filled from the local memory 17 into the data memory 3 of the instruction parallel processor 4 (step S63). The instruction parallel processor 4 performs setup processing using the DL provided to the data memory 3 (step S64) and the process result data is provided to the drawing engine 13 and so on (step S65). The drawing engine 13, which has received the process result data, converts it to drawing data and stores the converted drawing data in the local memory 17.

The original data related to media processing is filled in the data memory 3 of the instruction parallel processor 4 and media-processing setup processing is performed. Here the process result is provided to the audio interface 9. The drawing data stored in the local memory 17 is read by the video output engine 8 and outputted to the display monitor 16 (steps S66 and S67).

(Parallel Processing)

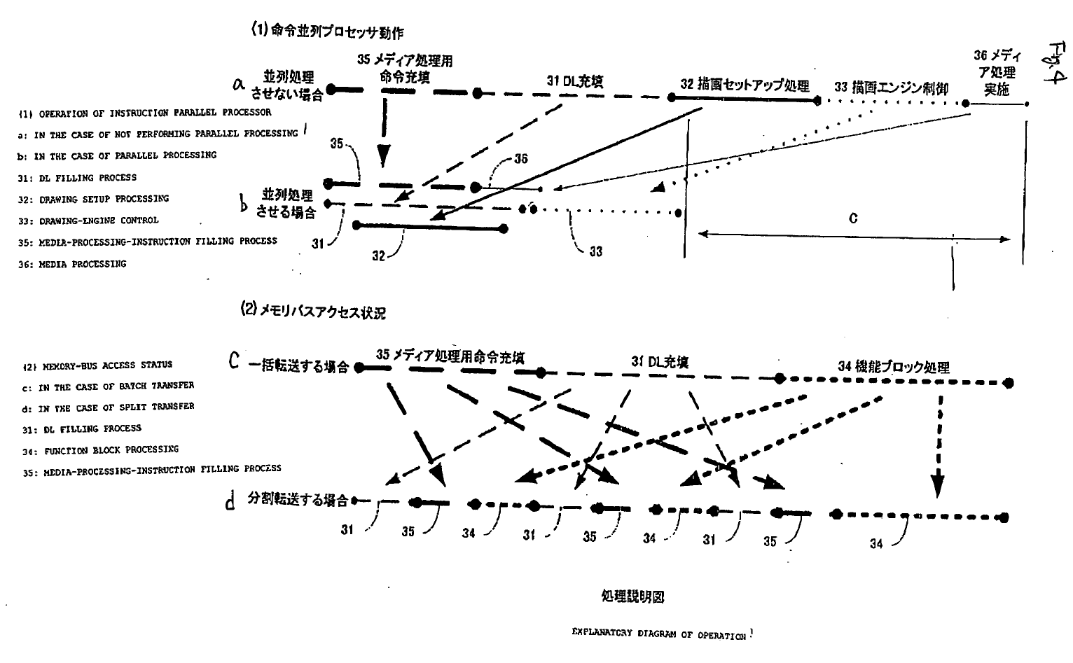

FIGS. 4(1) and 4(2) are explanatory diagrams showing the operating state of an instruction parallel processor. FIG. 4(1) shows the operating state of the instruction parallel processor 4 in FIG. 1, in which a process in the case where the instruction parallel processor 4 does not perform parallel processing (FIG. 4(1)a) and a process in the case where the instruction parallel processor 4 performs parallel processing (FIG. 4(1)b).

The DL filling process 31 shown in FIG. 4(1) is accessing to the bus arbitration unit 6 as an access request from the data memory bus 24. The data-memory access request 39 in FIG. 7 corresponds to it. The drawing-engine control 33 shown in FIG. 4(1) is accessing to the bus arbitration unit 6 as a write request from the processor expansion bus 19. The processor-expansion-bus access request 42 in FIG. 7 corresponds to it

A media-processing-instruction filling process 35 shown in FIG. 4(1) is accessing to the bus arbitration unit 6 as an access request from the instruction memory bus 25. An instruction-memory access request 40 in FIG. 7 corresponds to it. The control for the request from the data memory bus 24 and the request from the instruction memory bus 25 will be described later. The request from the processor expansion bus 19 is independent because the destination bus is different from that of the other requests, and so can be operated separately from the access for the data memory bus 24 and the instruction memory bus 25 in the bus arbitration unit 6.

(Memory-Access Arbitration)

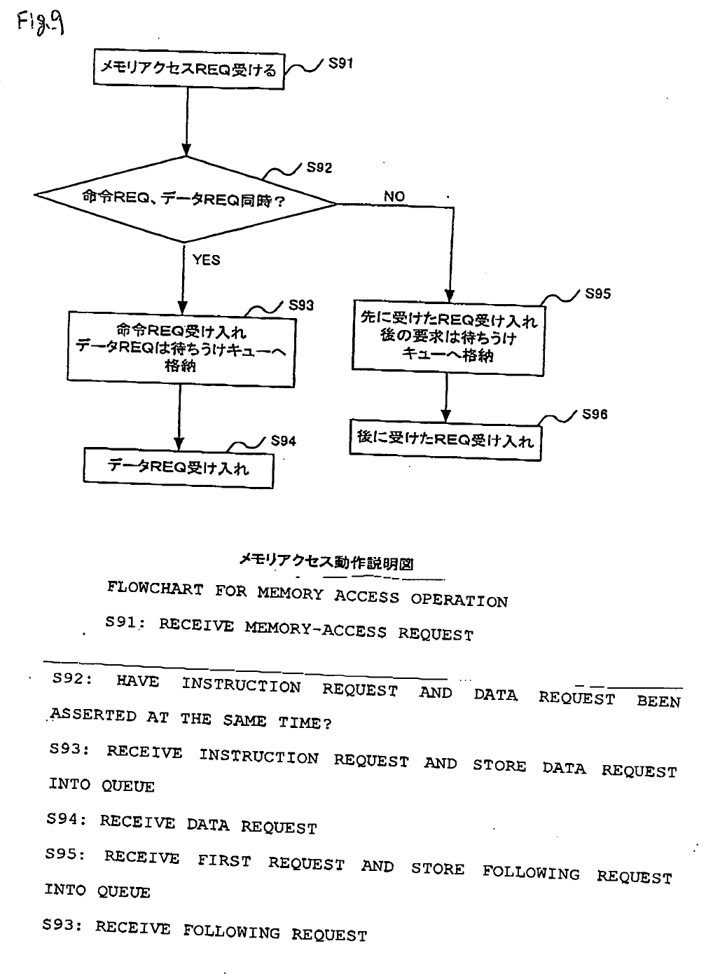

FIG. 9 is a flowchart for explaining the operation of the memory-access arbitration section 26 in FIG. 7. When the memory-access arbitration section 26 in the bus arbitration unit 6 receives a memory-access request (step S91), wherein when the request from the instruction memory bus 25 and the request from the data memory bus 24 have been asserted at the same time (step S92), the memory-access arbitration section 26 gives priority to receiving the access from the instruction memory bus 25, and so the request from the data memory bus 24 is stored in a queue (steps S93 and S94).

When the requests for memory access are not issued at the same time, or when the timings at which the request signals are asserted are different even in one cycle, the request from the bus that has first asserted the request signal is received, while the request from the bus that has asserted the request signal later is stored in a queue (step S95). The transfer request from the instruction parallel processor 4 is split by the internal-memory control unit 5 shown in FIG. 1, so that the data-memory access request and the instruction-memory access request are generally issued several times.

FIG. 8 is a diagram for explaining the flow of data in the bus arbitration unit 6, which is a schematic figure of FIG. 7. For the DL filling process 31 and the media-processing-instruction filling process 35 shown in FIG. 4(1), or for the access request from the data memory bus 24 and the access request from the instruction memory bus 25, DL data and a media-processing instruction code are read using the memory-bus bus 37 in FIG. 8. For the drawing-engine control 33 shown in FIG. 4(1), or for the access request from the processor expansion bus 19, parameters are set to the drawing engine 13 by using the processor-expansion-bus bus 38 in FIG. 8.

Thus, both of the request signals and data are independent in the bus arbitration unit 6, so that the drawing-engine control 33 can be performed independently. Also, the data-memory request and the instruction-memory request are controlled as shown in FIG. 9, so that both of which can be processed in parallel without being kept waiting for a long time.

As has been described, FIG. 4(1) shows the operating state of the instruction parallel processor 4 shown in FIG. 1. In FIG. 4(1), the DL filling process 31 means reading of a drawing instruction list from the local memory 17 to the instruction parallel processor 4, shown in step S63 of FIG. 6, and the media-processing-instruction filling process 35 means reading of media processing instruction from the local memory 17 to the instruction parallel processor 4, shown in step S62 of FIG. 6.

The drawing setup processing 32 shown in FIG. 4(1) means drawing setup processing shown in step S65 of FIG. 6. The drawing-engine control 33 shown in FIG. 4(1) means provision of process result data to the drawing engine 13, shown in step S65 of FIG. 6. The media processing 36 shown in FIG. 4(1) means media processing shown in step S67 of FIG. 6.

As shown in FIG. 4(1), by the parallel processing of the instruction parallel processor 4, the media-processing-instruction filling process 35, the DL filling process 31, and the drawing setup processing 32 can be performed in parallel; specifically, by performing the media processing 36 after the media-processing-instruction filling process 35 and performing the drawing-engine control 33 after the DL filling process 31, the processing time can be reduced by period C shown in FIG. 4(1)b.

FIG. 4(2) shows access statuses of batch transfer of data to the local memory 17 shown in FIG. 1 (FIG. 4(2)c) and split transfer of data (FIG. 4(2)d). In the media-processing-instruction filling process 35 and the DL filling process 31, instructions and data can be provided during their transfer requests, as shown in FIG. 4(2), by the control of the bus arbitration unit 6, shown in FIG. 9.

The function block processing 34 shown in FIG. 4(2) means the output of drawing data, shown in step S66 of FIG. 6. It also includes, for example, access to the local memory 17 by the video output engine 8 other than the drawing engine 13 for display processing.

As shown in FIG. 4(2), splitting the access to the local memory 17 (FIG. 4(2)d) allows the function block processing 34 to be started early, thus increasing the responsibility of the system as compared with that of batch transfer (FIG. 4(2)c).

(Third Embodiment)

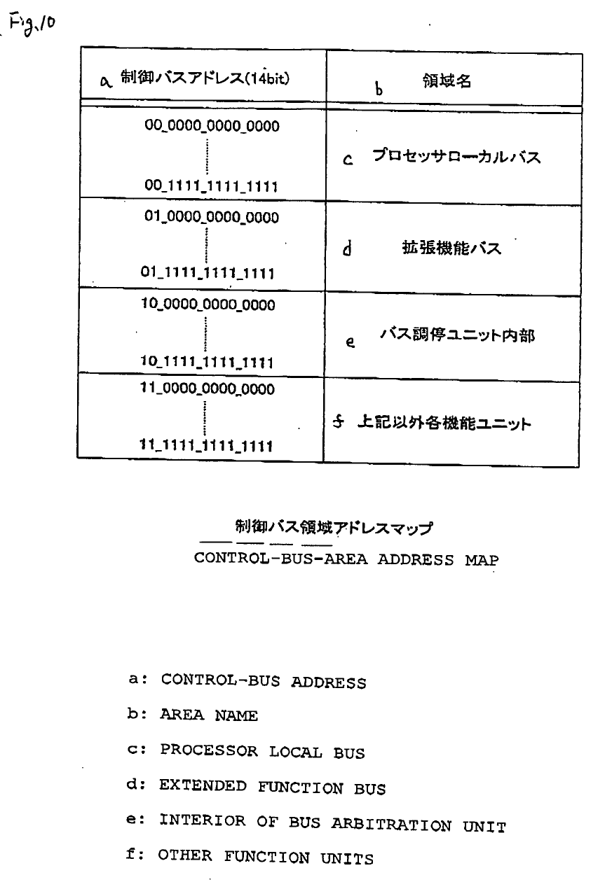

FIG. 10 is a diagram in which the address map of a control bus area is shown. The bus arbitration unit 6 accesses the processor local bus 18 having a width larger than that of the control bus 21 from the control bus 21. As shown in FIG. 10, the address width of the control bus 21 is 14 bits. The bus arbitration unit 6 determines whether the access from the control bus 21 is access to the processor local bus 18 by decoding the higher-order 2 bits of the address. The data widths of the control bus and the processor control bus are the same.

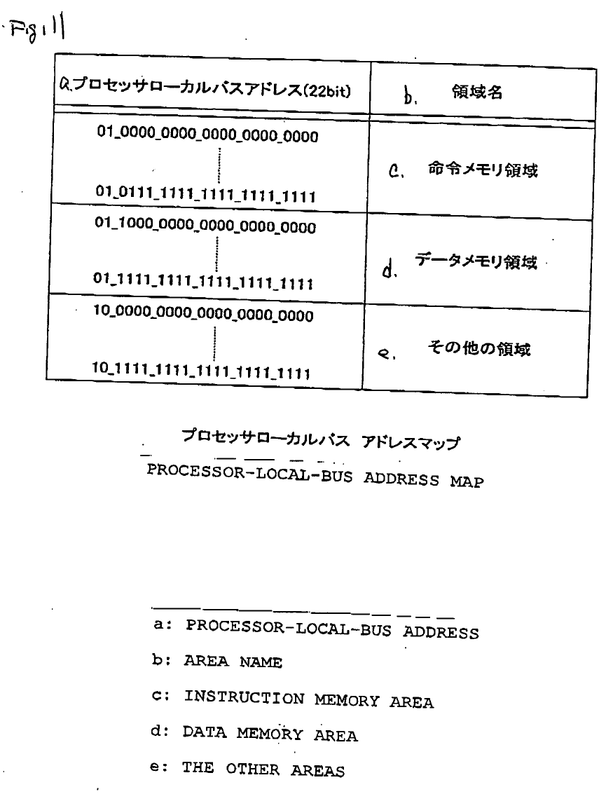

FIG. 11 is a diagram in which the address map of a processor local bus is shown. The processor local bus 18 has an address width of 22 bits, which is divided into an instruction memory area, a data memory area, and the other area depending on the address.

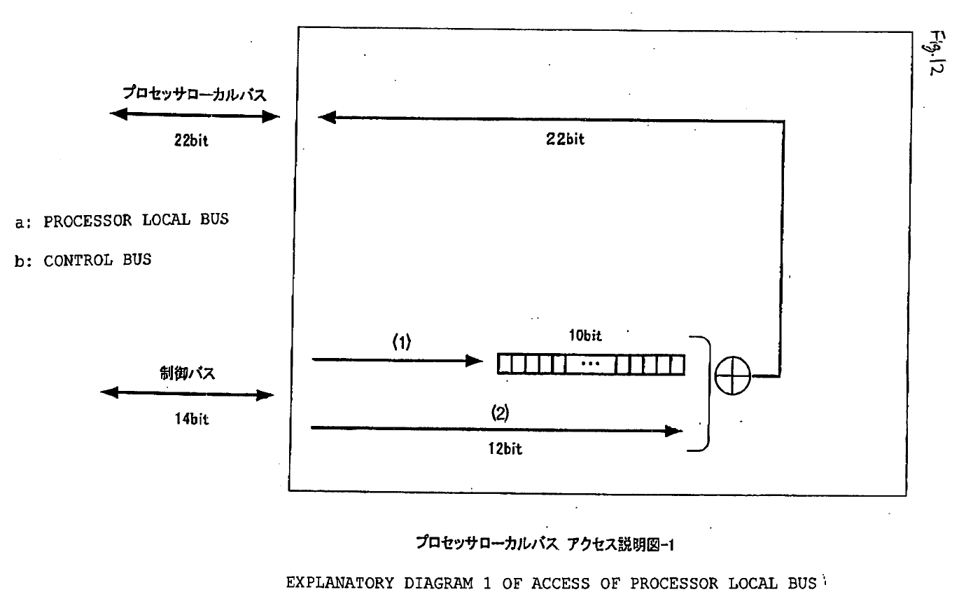

FIG. 12 is a diagram for explaining the access of the processor local bus 18. When access from the control bus 21 to the processor local bus 18 occurs, at least 10-bit processor local bus address is stored at the first access and the remaining address is designated at the second access, as shown in FIG. 12, because the address widths are different and as such, the entire address of the processor local bus 18 is determined, and so the access can be performed.

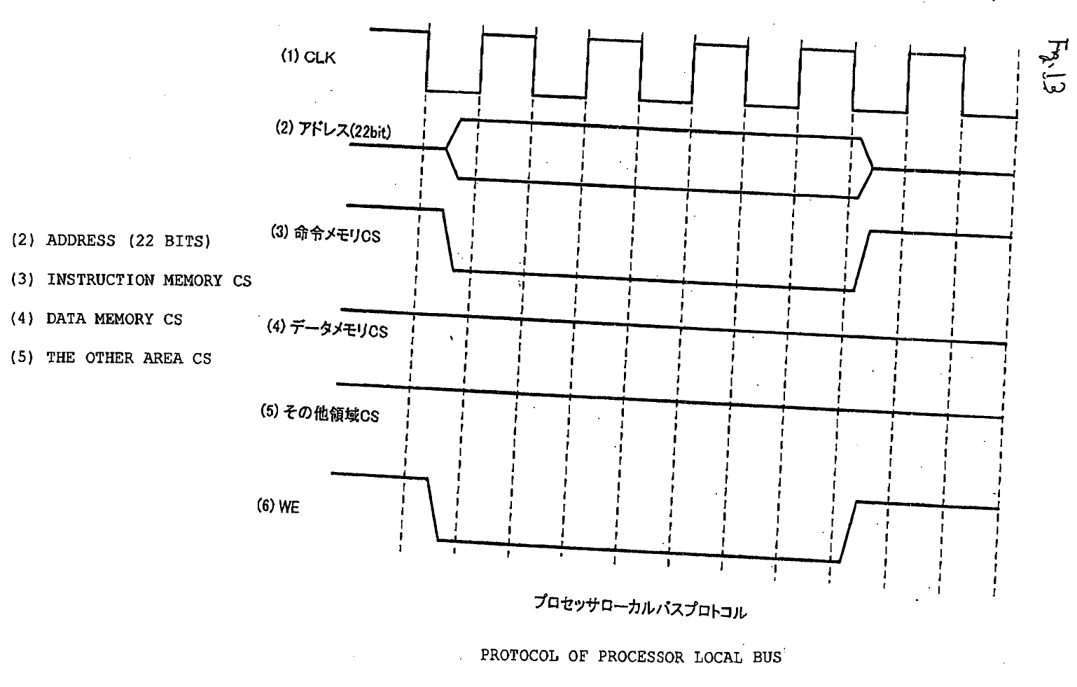

FIG. 13 is a time chart showing the protocol of the processor local bus 18, in which the write access of the processor local bus 18 into an instruction memory area is shown. As shown in FIG. 13, the processor local bus is specifies address destination by using an address (see FIG. 13) and chip select signals (see FIG. 13).

With the structure of FIG. 12, two times of access from the control bus 21 are needed to make one access from the control bus 21 to the processor local bus 18.

(Reuse of Higher-order Bits)

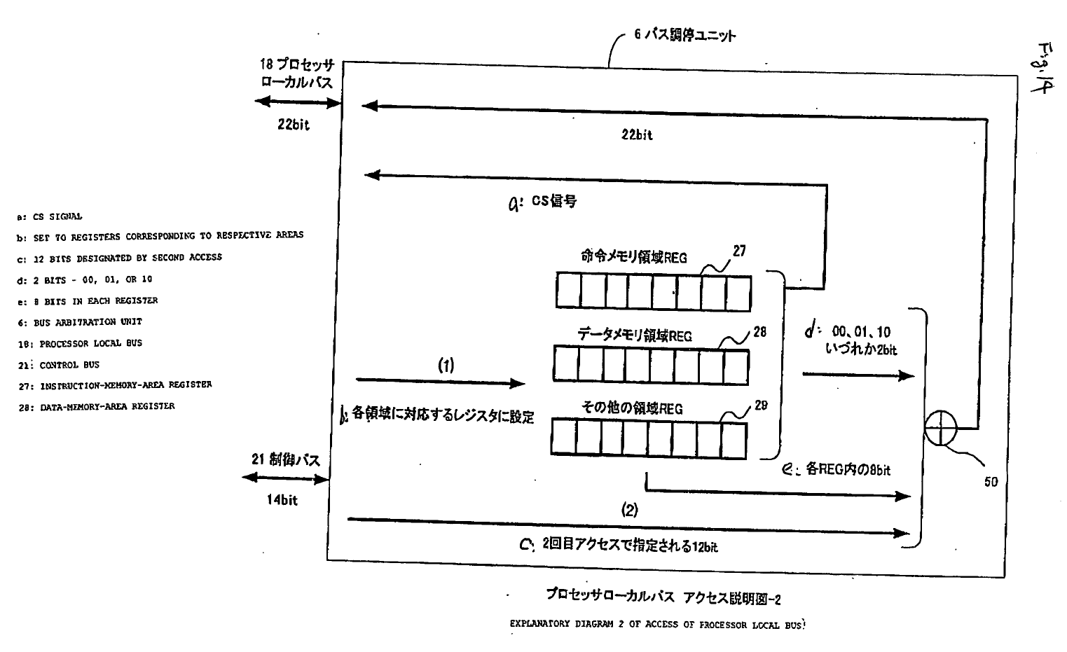

FIG. 14 is a diagram for explaining another access by the processor local bus 18. As shown in FIG. 14, the bus arbitration unit 6 is provided with three 8-bit processor-local-bus access registers 27, 28, and 29 corresponding to the instruction memory area, the data memory area, and the other area of the processor local bus 18, respectively. The processor-local-bus access registers 27, 28, and 29 store the address transferred from the control bus 21. The bus arbitration unit 6 is also provided with a connector 50 for connecting the address transferred from the control bus 21 with the address stored one of the registers 27, 28, and 29 and transferring it to the processor local bus 18.

The access to the registers allows 20-bit address of the processor local bus 18 to be given, when the bus arbitration unit 6 receives the following access from the control bus 21 to the processor local bus 18, by connecting the eight bits stored in the registers and 12 bits of the address of the following access.

Of the 20 bits, the lower-order 12 bits are given from the address of the following access, and the 13th bit to the 20th bit are given from the processor-local-bus access registers 27, 28, and 29. The remaining higher-order two bits are determined depending on by which of the three processor-local-bus access registers 27, 28, and 29 in the bus arbitration unit 6 the value is set last; 01 for the instruction memory area or the data memory area; 10 for the other area.

Unless a new access is given to the processor-local-bus access registers 27, 28, and 29 after the second access, the access that varies the lower-order 12 bits of the processor local bus 18 can be given to the processor local bus 18 by one access from the control bus 21 by giving the value of the processor-local-bus access registers 27, 28, and 29 and the higher-order two bits.

The bus arbitration unit 6 can generate a desired chip select signal (CS signal) depending on which of the three processor-local-bus access registers 27, 28, and 29 is accessed.

When the other region of the processor local bus 18, e.g., the instruction memory area, is accessed from the control bus 21 and then the data memory area is accessed, the first access, or the setting of eight bits to the processor-local-bus access registers 27, 28, and 29, can be started by accessing a processor-local-bus reset register present in the region allocated in the bus arbitration unit 6 shown in FIG. 10.

With the above structure, an address larger than the width of the control bus 21 can be generated by connecting the stored address with the address transferred from the control bus 21. Accordingly, only one access allows access to the processor local bus 18 having a large bus width. With the above structure, when an invariant address is stored in the registers 27 to 29, a desired address can be specified by one access from the control bus 21 by connecting the variable address transferred from the control bus 21 with the stored invariant address, so that the number of accesses can be reduced.

(Fourth Embodiment)

The processor expansion bus 19 and the extended function bus 20 include a register-access error flag for giving a notification of an error of access to the function block to the instruction parallel processor 4 when the instruction parallel processor 4 activates the function block by accessing the function block. Specifically, when the instruction parallel processor 4 fails to access the register of the coordinate conversion processor 12 or the drawing engine 13 via the bus arbitration unit 6, the coordinate conversion processor 12 or the drawing engine 13 asserts the register-access error flag to notify the instruction parallel processor 4 of it.

The instruction parallel processor 4 uses the register-access error flag for a branch instruction and so on as a condition flag. A method of using the register-access error flag in the drawing engine 13 will now be described.

The drawing engine 13 includes a parameter register group necessary for drawing, such as vertex coordinates and the inclination of a line segment, a drawing starting register for setting a drawing instruction and a starting flag, and a drawing end register indicative of whether drawing has terminated.

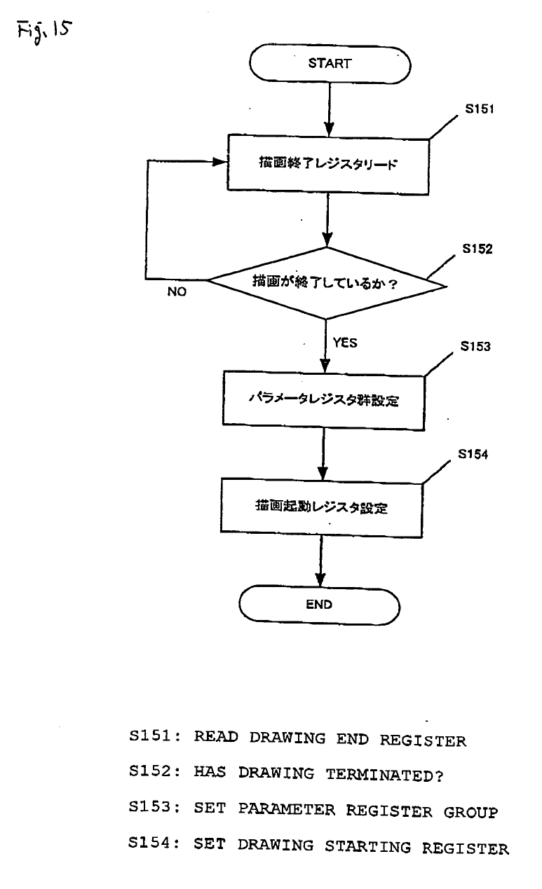

FIG. 15 is a flowchart until a normal drawing instruction is started. In step S151, the drawing end register is read. In step S152, it is determined whether the drawing has terminated, wherein when the drawing has terminated, the process moves to step S153, and when the drawing has not terminated, the process returns to step S151, where the drawing end register is read again. In step S153, the parameter register group necessary for drawing is set. In step S154, the drawing starting register is set to start a drawing instruction. In that case, the drawing end register is read and the determination on whether the drawing has terminated is branched off as a condition flag, so that it takes a lot of time to process.

(Register-Access Error Flag)

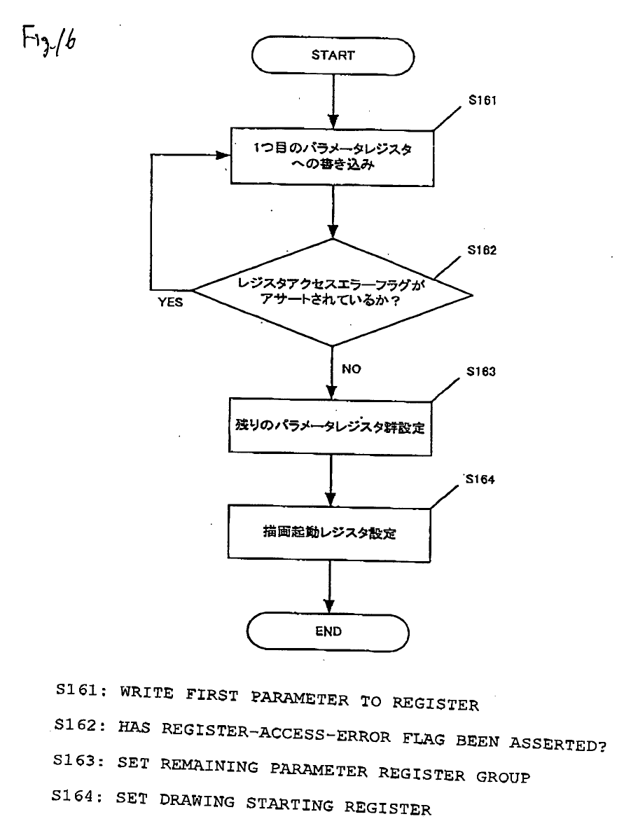

FIG. 16 is a flowchart until a normal drawing instruction is started in the case where a register-access error flag is used. The case where the register-access error flag is used will be described with reference to the drawing engine 13. Here the drawing engine 13 is provided with means for disabling access to the drawing engine 13 during the execution of drawing, whereby when the parameter of the following drawing instruction is written to the parameter register group, the register-access error flag is asserted without rewriting the contents of the parameter

As shown in FIG. 16, in step S161, the first parameter is written into the parameter register, wherein when drawing is under execution, the register-access error flag is asserted, so that the contents of the register to be written are not rewritten; when drawing has terminated, the register-access error flag is not asserted, so that the contents of the register to be written are rewritten.

In step S162, it is determined whether the register-access error flag has been asserted, wherein when the flag has not been asserted, the process moves to step S163; when the flag has been asserted, the process returns to step S161 to write the first parameter into the parameter register again. In step S163, the remaining parameter register group is set. In step S164, a drawing starting register is set to start a drawing instruction.

With this structure, notification of an access error is given by the register-access error flag. Accordingly, there is no need to read the drawing end register and the register-access error flag can be used as a condition flag for branching. This structure reduces the time to read the drawing end register to determine whether the drawing has terminated, allowing a drawing instruction to be activated at high speed.

(Two-Step Register)

Another structure of the drawing engine 13 will then be described. The drawing engine 13 has a two-step register for each of the parameters in the parameter register group. A parameter necessary for operation is written from the extended function bus 20 to the first-step register. When the drawing starting register is set to start the drawing instruction, the contents of the first-step register are copied into the second-step register.

The drawing engine 13 executes drawing on the basis of the parameter of the second-step register. This allows the parameter of the following drawing instruction to be written to the first-step register during the execution of some drawing instruction, thus offering the advantage that the drawing process and the parameter setting can be performed in parallel.

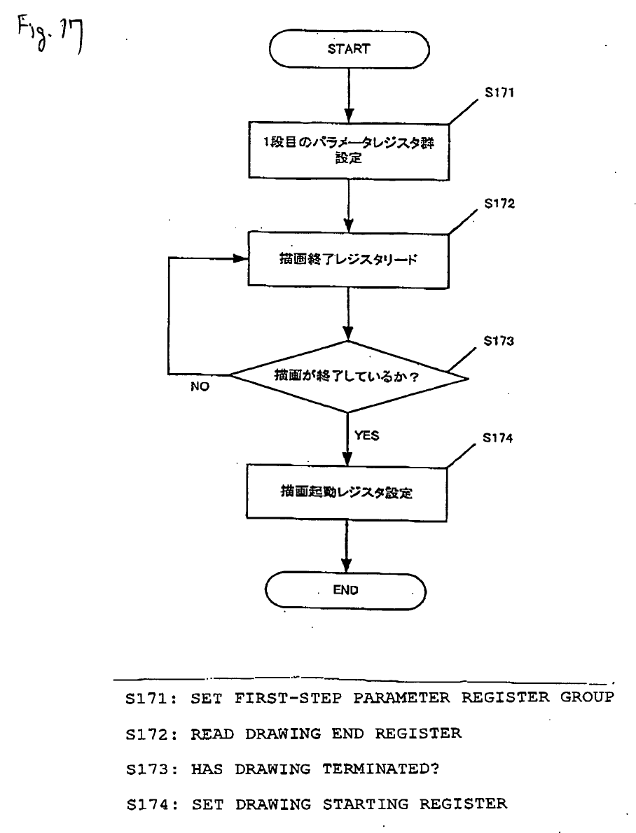

FIG. 17 is a flowchart until a normal drawing instruction in the two-step register is started. In step S171, a parameter necessary for a drawing instruction is set in the first-step parameter register group. Then, in step S172, a drawing end register is read. In step 173, it is determined whether the drawing has terminated, wherein when the drawing has terminated, the process moves to step S174; when the drawing has not terminated, the process returns to step S172 wherein the drawing end register is read again.

In step S174, the drawing starting register is set to start a drawing instruction. At that time, the contents of the first-step register are copied into the second-step register. The drawing engine performs drawing on the basis of the parameter of the second-step register, so that the parameter of the following drawing instruction can be set in the first-step register. Also in this case, there is a period to read the drawing end register and the determination on whether the drawing has terminated is branched off as a condition flag.

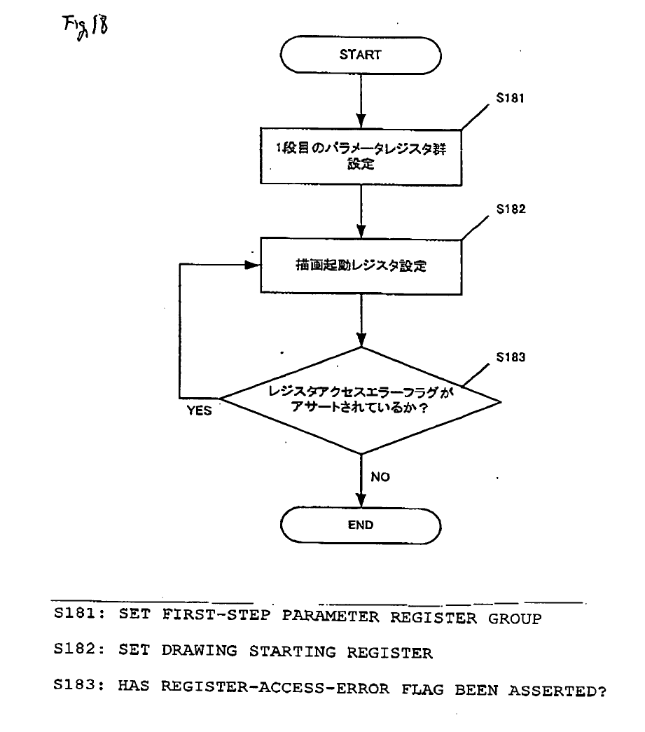

FIG. 18 is a flowchart until a drawing instruction is started when a register-access error flag is used in the two-step register. In step S181, a parameter necessary for drawing instruction is set in the first-step parameter register group. Then, in step S182, a drawing starting register is set. At that time, when the drawing is under execution, the register-access error flag is asserted, the drawing instruction is not activated, and the contents of the first-step register are not copied into the second-step register.

When the drawing has terminated, the register-access error flag is not asserted and the drawing instruction is activated. Then, in step S183, it is determined whether the register-access error flag has been asserted, wherein when the flag has been asserted, the process returns to step S182, wherein a drawing starting register is set again; wherein when the flag has not been asserted, the parameter of the following drawing instruction can be set in the first-step register because the drawing instruction is activated.

With this structure, there is no need to read the drawing end register and the register-access error flag can be used as a condition flag for branching, so that there is no need for the determination. This structure allows the drawing instruction to be activated at high speed and also allows the drawing process and the parameter setting to be performed in parallel.

Although the invention has been described with reference to an example in which a display list is read from a local memory, the list can be read from another memory other than the local memory. The above-described graphic processor may be mounted to a sophisticated car navigation system capable of map display and audio visual processing in parallel.

The present invention is provided with transfer means for transferring data in split form from a local memory to a processor. Accordingly, the time occupied by the local memory per access can be reduced, so that the start of other processes that use the local memory is not kept waiting for a long time, thus offering the advantage of increasing the responsibility of the system, so that the invention is suitable for information processor and the like.

1. An information processor comprising:
a memory unit that stores a display list;
a processing unit that reads the display list from the memory unit and performs a process according to the display list;
at least one function block that accesses the memory unit; and
a transfer unit that transfers data from the memory unit to the processing unit, wherein
the transfer unit transfers the data in split form.

2. The information processor according to claim 1, further comprising:
a first bus for access between the processing unit and the function block; and
a second bus for access between the processing unit and the memory unit, wherein
the first bus and the second bus are independent from each other.

3. The information processor according to claim 1 or 2, wherein
when transferring the data in split form, the transfer unit transfers the data in a predetermined order of priority in response to a data transfer request.

4. An information processor including a bus access unit that accesses a second bus having a width larger than that of a first bus from the first bus, the processor comprising:
a storage unit that stores an address transferred from the first bus as part of an address necessary for accessing the second bus;
an address generation unit that detects that an access request from the first bus to the second bus has been generated by the access to the storage means and generates part of the access necessary for accessing the second bus; and
a connecting unit that connects the address transferred from the first bus, the address stored in the storage unit, and the address generated by the address generation unit and transfers the connected address to the second bus.

5. An information processor comprising:
at least one function block;
a processor that activates the function block by the access to the function block; and
a notification unit that notifies the processor of an error of the access to the function block.

6. The information processor according to claim 5, further comprising:
a unit that disables access to the function block during the execution of the function block.

7. The information processor according to claim 5 or 6, wherein
the function block comprises:
a starting register for performing startup setting; and
a two-step parameter register having a first register that holds a parameter necessary for operation by the access from the processor and a second register that holds the contents from the first register at the setting of the starting register.
